(19) United States
(12) Patent Application Publication
(10) Pub. No.: US 2010/0110906 A1
(43) Pub. Date: May 6, 2010

(54) EFFICIENT FULL MESH LOAD TESTING OF NETWORK ELEMENTS

(75) Inventor: RAFI RAM, HERZLIYA (IL)

Correspondence Address: D. Kligler I.P. Services LTD, P.O. Box 25, Zippori, 17910, IL

(73) Assignee: CORRIGENT SYSTEMS LTD, TEL AVIV (IL)

(21) Appl. No.: 12/261,072

(22) Filed: Oct. 30, 2008

(51) Int. Cl. G06F 11/00

(52) U.S. Cl. 370/252

(57) ABSTRACT

A method for testing a network element that includes multiple ports includes assigning one or more of the ports to serve as input and output test ports. One or more of the ports other than the test ports are terminated with respective loopback connections. The network element is configured to forward packets entering the network element at the input test port, so as to cause the packets to be distributed among the terminated ports and to exit the network element, after re-entering the network element at one or more of the terminated ports, at the output test port.

A first sequence of the packets is applied to the input test port, and a second sequence of the packets exiting the network element at the output test port is received. An operation of the network element is verified by evaluating the second sequence.

### FIELD OF THE INVENTION

The present invention relates generally to communication networks, and particularly to methods and systems for testing network elements.

### BACKGROUND OF THE INVENTION

Network elements, such as network routers and other types of switches, are typically tested to verify compliance with their specified performance. In particular, a network element may be subjected to load tests, which test the network element's ability to function and perform under heavy traffic load conditions.

### SUMMARY OF THE INVENTION

An embodiment of the present invention provides a method for testing a network element that includes multiple ports, the method including:

assigning one or more of the ports to serve as input and output test ports;

terminating one or more of the ports other than the input and output test ports with respective loopback connections, such that a packet exiting the network element at a given terminated port will re-enter the network element at the given terminated port;

configuring the network element to forward packets entering the network element at the input test port, so as to cause the packets to be distributed among the terminated ports and to exit the network element, after re-entering the network element at one or more of the terminated ports, at the output test port;

applying a first sequence of the packets to the input test port;

receiving a second sequence of the packets exiting the network element at the output test port; and

verifying an operation of the network element by evaluating the second sequence.

In some embodiments, the first sequence includes multiple sub-sequences of the packets having different, respective packet attributes, and configuring the network element includes causing the network element to forward the sub-sequences over respective, different forwarding paths responsively to the packet attributes.

In an embodiment, the sub-sequences are associated with different, respective Virtual Local Area Networks (VLANs), and causing the network element to forward the sub-sequences over the forwarding paths includes defining point-to-point VLAN connections between pairs of the ports. Defining the point-to-point VLAN connections may include defining a bidirectional VLAN connection, which specifies that the packets that arrive at a first port and are associated with a first VLAN are to be forwarded to a second port and further specifies that the packets that arrive at the second port and are associated with a second VLAN are to be forwarded to the first port, and setting the second VLAN to a value that is not associated with any of the sub-sequences. In an alternative embodiment, the packet attributes include Media Access Control (MAC) addresses.

In some embodiments, the ports have respective maximum specified ingress and egress bandwidths, and configuring the network element includes causing the packets to be distributed among the ports such that the packets utilize the ports to their respective maximum ingress and egress bandwidths. In an embodiment, configuring the network element includes causing the packets that are forwarded from a given port to be distributed among the other ports responsively to the respective egress bandwidths of the other ports. In a disclosed embodiment, the ports include Ethernet ports.

There is additionally provided, in accordance with an embodiment of the present invention, apparatus for testing a network element that includes multiple ports, the apparatus including:

a packet generation/analysis unit, which is coupled to apply a first sequence of packets to an input test port assigned from among the ports, to receive a second sequence of the packets exiting the network element at an output test port assigned from among the ports, and to verify an operation of the network element by evaluating the second sequence, wherein one or more of the ports other than the input and output test ports are terminated with respective loopback connections such that a packet exiting the network element at a given terminated port will re-enter the network element at the given terminated port; and

a processor, which is coupled to configure the network element to forward the packets entering the network element at the input test port, so as to cause the packets to be distributed among the terminated ports and to exit the network element, after re-entering the network element at one or more of the terminated ports, at the output test port.

There is also provided, in accordance with an embodiment of the present invention, a computer software product for testing a network element, which includes multiple ports and is connected to a packet generation/analysis unit that applies a first sequence of packets to an input test port assigned from among the ports, receives a second sequence of the packets exiting the network element at an output test port assigned from among the ports, and verifies an operation of the network element by evaluating the second sequence, wherein one or more of the ports other than the input and output test ports are terminated with respective loopback connections such that a packet exiting the network element at a given terminated port will re-enter the network element at the given terminated port, the product including a computer-readable medium, in which program instructions are stored, which instructions, when read by a computer, cause the computer to configure the network element to forward the packets entering the network element at the input test port, so as to cause the packets to be distributed among the terminated ports and to exit the network element, after re-entering the network element at one or more of the terminated ports, at the output test port.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a system for full mesh testing of a network element, in accordance with an embodiment of the present invention;

FIG. 2 is a diagram showing a connection configuration matrix for performing full mesh testing of a network element, in accordance with an embodiment of the present invention;

FIGS. 3A and 3B are diagrams that schematically illustrate packet forwarding paths in a network element subjected to full mesh testing, in accordance with an embodiment of the present invention; and

FIG. 4 is a flow chart that schematically illustrates a method for full mesh testing of a network element, in accordance with an embodiment of the present invention.

### DETAILED DESCRIPTION OF EMBODIMENTS

### Overview

A packet Network Element (NE), such as a router or other type of switch, typically comprises multiple ports. The ports usually serve as both ingress ports, via which packets enter the NE, and egress ports, via which packets exit the NE. The NE forwards packets among the ports in accordance with a certain forwarding scheme. In order to test the NE operation under heavy traffic conditions, NEs are sometimes subjected to full mesh testing. Full mesh testing subjects the tested NE to a scenario in which the traffic forwarded from a given port to all the different egress ports is distributed in proportion to the respective capacities of the egress ports. Typically, each port is loaded to its maximum traffic capacity in both ingress and egress directions.

Some known testing schemes apply full mesh testing by injecting and extracting packets into and out of the different ports of the tested NE. Such known schemes, however, employ specialized test equipment for generating and analyzing packets per each tested port. As such, these schemes tend to be complex and expensive, especially when the tested NE has a large number of ports.

Embodiments of the present invention that are described herein provide improved methods and systems for testing packet NEs. These methods and systems are useful in reducing the cost and complexity of testing. In some embodiments, two of the ports of the tested NE are assigned to serve as test ports. Each test port is connected to a respective packet generator/analyzer, which injects packet sequences to the NE via the test port and examines the packets exiting the NE at the test port. The other ports of the NE are terminated with respective loopback connections, such that a packet exiting the NE at a given terminated port will re-enter the NE at the same port. (Although the embodiments described herein use dual-function packet generators/analyzers, the disclosed methods and systems can also be used with separate packet generators and packet analyzers. For example, a packet generator can be connected to one test port, while a packet analyzer is connected to the other test port.)

For testing purposes, the NE is configured with a specially-designed forwarding scheme. This forwarding scheme causes packets entering the NE at any port to be distributed among the other ports. Consequently, packets entering the NE at a given test port pass in and out of different terminated ports until they ultimately exit the NE via the other test port. This sort of forwarding scheme can be designed to simulate full mesh conditions, as is described and demonstrated hereinbelow.

In some embodiments, each packet generator/analyzer generates multiple packet sub-sequences simultaneously, such that each sub-sequence is associated with a different Virtual Local Area Network (VLAN). The NE is configured to forward packets associated with different VLANs over respective, different paths. An example of a VLAN-based configuration, which is implemented by setting up multiple point-to-point VLAN connections between pairs of ports, is described further below. As an alternative to using VLANs, the packet sub-sequences can be differentiated and forwarded over different paths based on other packet attributes, such as Media Access Control (MAC) addresses.

In some embodiments, the scheme described above is used to evaluate packet loss under full mesh conditions. When testing the NE, a given packet generator/analyzer generates packet sub-sequences that enter the NE at the corresponding test port. The other packet generator/analyzer evaluates the packets exiting the NE at the other test port and attempts to detect packet loss. If all the packets entering a given test port successfully reach the other test port, the test is declared successful. Otherwise, the test is regarded as failed.

The methods and systems described herein enable testing of network elements using only a small number of packet generation/analysis ports. By configuring the NE with specially-designed forwarding schemes, and by means of the loopback connections, the disclosed test methods can operate the NE under full mesh conditions using only two packet generators/analyzers. As such, the disclosed techniques considerably reduce the size, cost and complexity associated with network element testing.

### System Description

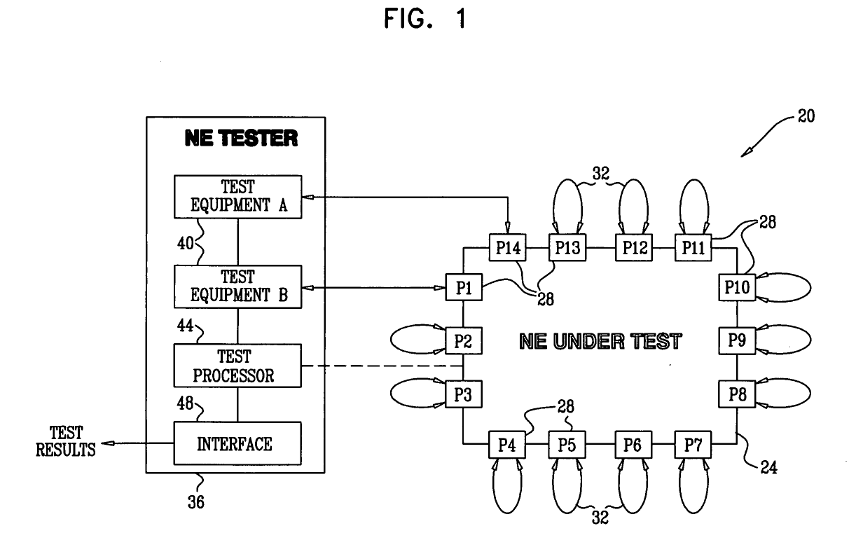

FIG. 1 is a block diagram that schematically illustrates a system 20 for testing a Network Element (NE) 24, in accordance with an embodiment of the present invention. In the description that follows, NE 24 comprises a simple packet network switch. However, the methods and systems described herein can be used with various other sorts of packet network switches and other network elements, such as routers, bridges and access concentrators.

NE 24 comprises multiple ports 28 via which the NE receives and transmits packets when it is operating in a communication network. Typically, ports 28 are bidirectional. In other words, each port 28 functions both as an ingress port via which packets enter the NE, and as an egress port via which packets exit the NE. In the present example, ports 28 comprise bidirectional Ethernet™ ports.

NE 24 is specified to transfer packets among its ports in accordance with a certain forwarding scheme, such as Ethernet layer 2 switching or Internet Protocol (IP) routing. Typically, NE 24 is specified to forward packets properly even under full traffic conditions, i.e., when ports 28 are loaded to their maximum capacity. In order to verify compliance with this requirement, system 20 applies full mesh, full load testing to the NE, using methods that are described in detail below.

Full mesh testing typically means that the traffic forwarded within the NE from a given ingress port is distributed among the egress ports in proportion to their respective capacities (bandwidths). For equal bandwidth ports, the traffic is distributed evenly among the egress ports. When conducting full load testing, each port is loaded with packet traffic to its maximum specified capacity (bandwidth) in both ingress and egress directions. For example, an Ethernet port can be fully loaded by subjecting it to a stream of 64-byte Ethernet frames having a 96 nSec inter-frame gap. Under these conditions, the NE is typically expected to forward all ingress packets to their destinations without packet loss.

In order to conduct the full mesh testing process, two of ports 28 are assigned to serve as test ports. The other ports are terminated with loopback connection 32 (and are therefore referred to herein as terminated ports). A given loopback connection that terminates a given port causes any packet exiting the NE at this port to re-enter the NE at the same port. Note that the two edges of a given loopback connection are connected to the same port, a feature that simplifies the interconnection/wiring of the test setup.

In the present example, NE 24 comprises a total of fourteen ports denoted P1 . . . P14. Ports P1 and P14 are assigned to serve as the test ports, and ports P2 . . . P13 are terminated with loopback connections. In alternative embodiments, the NE may comprise any suitable number of ports, and any two of these ports can be selected to serve as test ports.

System 20 comprises a tester 36, which subjects NE 24 to full mesh testing. Tester 36 comprises two packet generators/analyzers 40, denoted TEST EQUIPMENT A and B in the figure. Each packet generator/analyzer is connected to one of the assigned test ports. The packet generator/analyzer generates a stream of packets that enter the NE at the respective test port. In addition, the packet generator/analyzer receives the packets that exit the NE at the respective test port, and examines these packets to detect packet loss. Test equipment that can be used for this purpose may comprise, for example, the Smartbits® product family offered by Spirenet® Communications plc (Crawley, United Kingdom), products offered by IXIA, Inc. (Calabasas, Calif.), or any other suitable product.

Tester 36 further comprises a test processor 44, which controls packet generators/analyzers 40 and otherwise carries out the methods described herein. In particular, processor 44 configures NE 24 so that the packets entering the NE at one of the test ports will be distributed among the terminated ports and will ultimately exit the NE at the other test port. The forwarding scheme configured by processor 44 makes use of the loopback connections. A packet that enters the NE at one test port and reaches a given terminated port will exit and re-enter the NE at the same port. The packet will then be forwarded to another port in accordance with the forwarding scheme, en route to the other test port.

Thus, by means of the loopback connections and the forwarding scheme configured by processor 44, tester 36 causes NE 24 to operate under full mesh conditions. Several examples of forwarding schemes, which may be used by processor 44 to configure NE 24, are explained and demonstrated in detail further below.

Tester 36 comprises an interface 48, via which processor 44 outputs test results, e.g., an indication as to whether NE 24 passed or failed the test. The test results can be displayed using a suitable output device to an operator, stored in a memory for subsequent use, communicated to another computerized system, or used in any other suitable way.

Tester 36 may be deployed, for example, in a production line that manufactures the network elements, at a customer site for testing network elements before installation in a network, or in any other configuration. In some embodiments, the functions of processor 44, and possibly of other elements of tester 36, are embodied in a test station together with other testing functions. Typically, processor 44 comprises a general-purpose computer, which is programmed in software to carry out the functions described herein. The software may be downloaded to the computer in electronic form, over a network, for example, or it may, alternatively or additionally, be provided and/or stored on tangible media, such as magnetic, optical, or electronic memory.

### Network Element Test Configuration Using VLAN Connections

Many network elements support Virtual Local Area Networks (VLANs). VLANs are defined in IEEE standard 802.1Q™-2005, entitled “IEEE Standard for Local and Metropolitan Area Networks—Virtual Bridged Local Area Networks,” May 19, 2006, which is incorporated herein by reference.

In some embodiments of the present invention, the packet sequence generated by each packet generator/analyzer 40 comprises multiple sub-sequences whose packets are associated with different, respective VLANs. In other words, each packet generator/analyzer generates multiple packet flows, each flow comprising packets that are associated with a different VLAN.

In these embodiments, the forwarding scheme of NE 24 applies different forwarding to packets belonging to different VLANs. For example, processor 44 may configure NE 24 by defining point-to-point VLAN-based connections between pairs of ports 28. Each point-to-point connection is set up between two Connection Termination Points (CTPs, also sometimes referred to as Attachment Circuits—ACs). Each CTP is defined by a port number (e.g., ports P1 . . . P14 of NE 24) and by a VLAN identifier (VID). A point-to-point connection between the CTP <port n, VID 101> and the CTP <port m, VID 1101> specifies that packets, which enter the NE at port n and are associated with VLAN 101, will be forwarded to port m. Packets that enter the NE at port m and are associated with VLAN 1101 will be forwarded to port n.

A given port may participate in multiple point-to-point connections, possibly with different VID values. Thus, for example, the NE 24 may be configured to forward packets entering at port n to port m if the packets belong to VLAN X, and to port k (k≠m) if the packets belong to VLAN Y (Y≠X). This mechanism enables NE 24 to forward each sub-sequence (flow) produced by generator/analyzer 40 along a different route, depending on the VLAN with which the sub-sequence is associated. (Similar forwarding functionality can also be implemented using Media Access Control (MAC) addresses, as is explained further below.)

Processor 44 may define any suitable set of VLAN-based point-to-point connections among the ports of NE 24. In order to perform full mesh, full load testing of the NE, the connections are defined so that:

(1) Each sub-sequence is forwarded along a path that enters the NE at one test port and exits the NE at the other test port. The path is determined by the VLAN associated with the sub-sequence.

(2) By means of the different paths, the packets forwarded from a given port are distributed across all the different egress ports evenly, and load each port to its maximum specified capacity.

Although the embodiments described herein refer mainly to full mesh testing, the methods and systems described herein are in no way limited to this sort of test. In alternative embodiments, NE 24 can be configured to apply various other forwarding schemes in order to apply various other types of testing.

### Full Mesh Testing Configuration

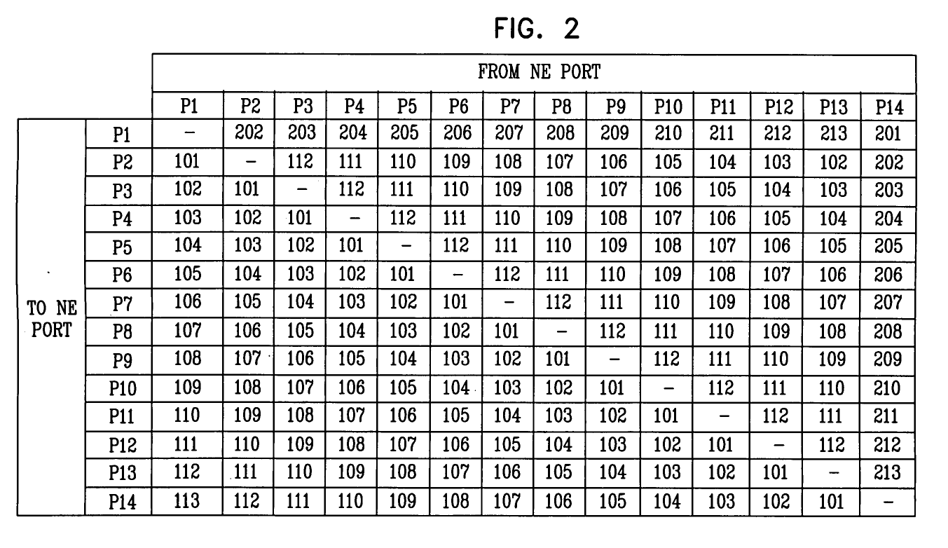

FIG. 2 is a diagram showing a connection configuration matrix for performing full mesh testing of NE 24, in accordance with an embodiment of the present invention. NE 24 is assumed to comprise fourteen equal-rate ports. The NE is connected to tester 36 and some of its ports are terminated with loopback connections, according to the configuration of FIG. 1 above.

In the present example, the packet generator/analyzer connected to port P1 generates thirteen equal-rate packet flows simultaneously. The rate of each flow is set to the nominal port rate divided by thirteen. The packets in the first flow are associated with VLAN 101 (i.e., have a VID=101), the packets in the second flow are associated with VLAN 102, and so on. Thus, port P1 accepts at its input thirteen flows having VID values of 101 . . . 113. The other packet generator/analyzer, which is connected to port P14, generates another set of thirteen equal-rate packet flows. These flows have VID values of 201 . . . 213.

Processor 44 configures NE 24 in accordance with the table of FIG. 2. Each table entry defines how each packet that enters a given port is forwarded, depending on the VID value of the packet. For example, a packet having VID=105 that enters at port P1 will be forwarded to port P6. A packet having VID=112 that enters port P9 will be forwarded to port P8.

As noted above, the point-to-point connections define a bidirectional connection between two CTPs. The table above, however, defines unidirectional forwarding. In some embodiments, processor 44 defines the forwarding scheme of FIG. 2 by entering a dummy VID value, which is not used by any of the packets, in one of the CTPs. For example, processor 44 may configure NE 24 with the forwarding scheme of FIG. 2 by setting up 14×13=182 point-to-point connections, one connection for each table entry. The 182 connections are set up between <port n, VID=TABLE(m,n)> and <port m, VID=1101>, wherein TABLE(m,n) denotes the VID in row m and column n of the table of FIG. 2, n≠m. VID=1101 is a dummy value, which is not used by any of the packet flows. Alternatively, any other suitable dummy VID value can be used.

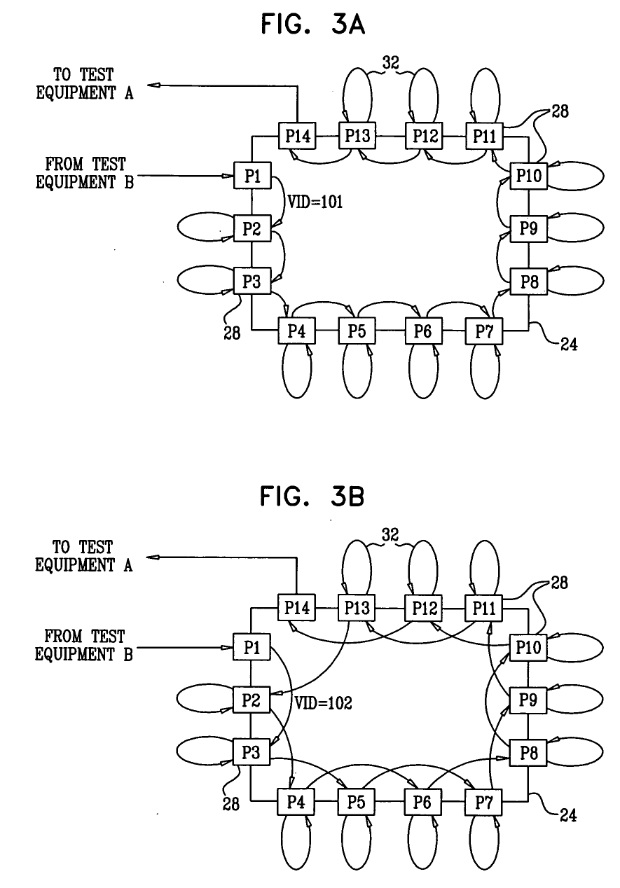

FIGS. 3A and 3B are diagrams that schematically illustrate examples of packet forwarding paths in NE 24, when the NE is configured with the forwarding scheme of FIG. 2 above, in accordance with an embodiment of the present invention. The examples of FIGS. 3A and 3B are best understood by referring simultaneously to FIG. 2.

FIG. 3A shows the forwarding path that is traversed by the packet flow that enters the NE at port P1 and has VID=101. Following the definitions of FIG. 2, packets having VID=101 are forwarded from port P1 to port P2. Port P2 is terminated with a loopback connection, and therefore the packets re-enter the NE at the same port. According to FIG. 2, packets entering at port P2 and having VID=101 are forwarded to port P3, which is also terminated with a loopback connection. As can be seen in FIG. 3A, packets entering the NE at port P1 and having VID=101 are forwarded (using the loopback connections) over the path P1-P2-P3-P4- . . . -P12-P13-P14, and exit the NE at port P14.

FIG. 3B shows the forwarding path that is traversed by the packet flow that enters the NE at port P1 and has VID=102. Following the definitions of FIG. 2, packets having VID=102 are forwarded from port P1 to port P3, which is terminated with a loopback connection. After exiting and re-entering the NE at port P3, the packets are forwarded to port P5, which is also terminated with a loopback connection. Thus, as can be seen in FIG. 3B, packets entering the NE at port P1 and having VID=102 are forwarded (using the loopback connections) over the path P1-P3-P5-P7-P9-P11-P13-P2-P4-P6-P8-P10-P12-P14, and exit the NE at port P14.

The other packet flows (a total of thirteen flows entering at port P1 and another thirteen entering at port P14) are forwarded internally to the NE and over the loopback connections according to the definitions in FIG. 2. Each flow enters the NE at one of the test ports, follows a certain path among the ports and over the loopback connections, and exits at the other test port. As can be appreciated, the forwarding scheme of FIG. 2 distributes the packets forwarded from each port evenly among the different egress ports, and loads the ingress and egress directions of each port to their full capacity. In other words, the scheme of FIG. 2 causes the NE to operate under full mesh conditions.

Both packet generators/analyzers 40 accept the packets exiting the NE at test ports P1 and P14. The packet generators/analyzers verify that the packet flows are complete, i.e., that no packets are lost. Typically, the test is declared successful if no packets are lost, and vice versa.

The forwarding scheme described in FIGS. 2, 3A and 3B is an example, which was chosen purely for the sake of conceptual clarity. In alternative embodiments, NE 24 can be configured with any other suitable forwarding scheme that causes incoming packets to be distributed among the different ports. Some of these schemes may distribute the traffic approximately evenly among the different egress ports and load each port to its full capacity, so as to emulate full mesh testing.

The embodiments described above use VLAN-based connections in order to distribute packets over multiple forwarding paths in the network element. However, the methods and systems described herein are in no way limited to VLAN-based differentiation. In alternative embodiments, any other suitable attribute can be used for associating packets with multiple flows and assigning each flow a different forwarding path through the tested network element. Generally, the different sub-sequences applied to the NE are marked with different values of a certain attribute (e.g., VLAN). The forwarding scheme used for testing the NE assigns each sub-sequence a different forwarding path through the NE, based on the attribute value.

As another example, the attribute values used for differentiation may comprise Media Access Control (MAC) addresses. In these embodiments, the network element may be configured with an Access Control List (ACL), which defines different forwarding paths for a predefined set of different MAC addresses. The different packet flows generated that are applied to the NE are assigned these different MAC addresses, and are thus forwarded over the different paths by the NE.

In the embodiments described herein, every port of the NE participates in the full mesh testing procedure, serving either as a test port or as a terminated port. In alternative embodiments, however, testing may be applied to only a subset of the ports. In these embodiments, one or more of the NE ports may be excluded from the test, and the forwarding scheme does not forward packets to these ports.

The embodiments described above address a configuration having two packet generators/analyzers and two test ports. In alternative embodiments, however, the NE can be tested with a larger number of packet generators/analyzers and test ports, or with only a single packet generator/analyzer and a single test port.

Although the embodiments described herein use dual-function packet generators/analyzers, the disclosed methods and systems can also be used with separate packet generators and packet analyzers. These elements are regarded herein collectively as a packet generation and analysis unit, which generates the packets for testing the NE, receives the packets exiting the NE and evaluate the exiting packets in order to detect packet loss.

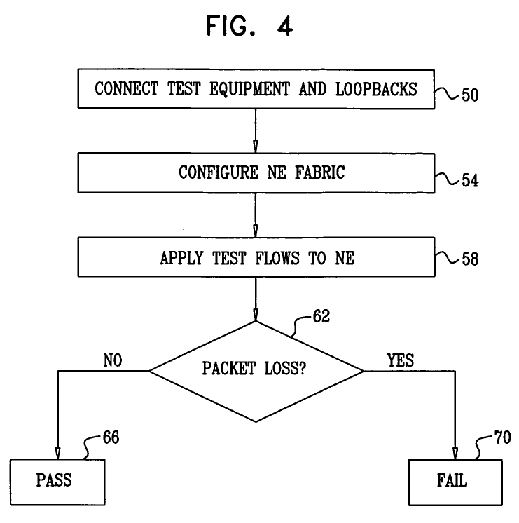

FIG. 4 is a flow chart that schematically illustrates a method for full mesh testing of a network element, in accordance with an embodiment of the present invention. The method begins with a user, such as a test engineer, connecting NE 24 to the test setup described in FIG. 1 above, at a setup connection step 50. Two ports of the NE under test are connected to packet generators/analyzers 40, and the other ports are terminated with loopback connections.

The user (using processor 44) then configures NE 24 with the appropriate forwarding scheme, at a configuration step 54. The forwarding scheme may comprise, for example, the scheme described in FIGS. 2, 3A and 3B, or any other suitable scheme. Typically, processor 44 configures the NE by programming its fabric (not shown), i.e., the component or components that carry out the forwarding scheme of the NE. In the embodiments described herein, configuration is carried out by processor 44. In some embodiments, the NE may be configured using Simple Network Management Protocol (SNMP) commands, using a Command Line Interface (CLI) such as Transaction Language 1 (TL1), using a graphical application such as a Hyper Text Transfer Protocol (HTTP) browser, or using any other suitable means.

Once the NE is properly configured and connected to the test setup, packet generators/analyzers 40 generate the appropriate packet sequences into the NE's designated test ports, at a packet generation step 58. The NE forwards the incoming packets internally, in accordance with the configured forwarding scheme. The packet generators/analyzers receive the packets that exit the NE at their respective test ports and check for packet loss, at a packet loss checking step 62.

In some embodiments, the packet generators/analyzers may detect packet loss by comparing the packets entering the NE at one test port to the packets exiting the NE at the other test port. Alternatively, the packets generated by the packet generators/analyzers may be numbered or otherwise marked, so that packet loss can be detected by evaluating only the exiting packets.

If all the packets that were input to each of the test ports are received successfully at the other test port, the test is declared successful, at a success termination step 66. Otherwise, the test is regarded as failed, at a failure termination step 70.

Although the embodiments described herein mainly address full mesh testing of packet network elements, the principles of the present invention can also be used for other testing applications, such as partial mesh or hub/spoke-like traffic flow testing.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A method for testing a network element that includes multiple ports, the method comprising:
assigning one or more of the ports to serve as input and output test ports;
terminating one or more of the ports other than the input and output test ports with respective loopback connections, such that a packet exiting the network element at a given terminated port will re-enter the network element at the given terminated port;
configuring the network element to forward packets entering the network element at the input test port, so as to cause the packets to be distributed among the terminated ports and to exit the network element, after re-entering the network element at one or more of the terminated ports, at the output test port;
applying a first sequence of the packets to the input test port;
receiving a second sequence of the packets exiting the network element at the output test port; and
verifying an operation of the network element by evaluating the second sequence.

2. The method according to claim 1, wherein the first sequence comprises multiple sub-sequences of the packets having different, respective packet attributes, and wherein configuring the network element comprises causing the network element to forward the sub-sequences over respective, different forwarding paths responsively to the packet attributes.

3. The method according to claim 2, wherein the sub-sequences are associated with different, respective Virtual Local Area Networks (VLANS), and wherein causing the network element to forward the sub-sequences over the forwarding paths comprises defining point-to-point VLAN connections between pairs of the ports.

4. The method according to claim 3, wherein defining the point-to-point VLAN connections comprises defining a bidirectional VLAN connection, which specifies that the packets that arrive at a first port and are associated with a first VLAN are to be forwarded to a second port and further specifies that the packets that arrive at the second port and are associated with a second VLAN are to be forwarded to the first port, and setting the second VLAN to a value that is not associated with any of the sub-sequences.

5. The method according to claim 2, wherein the packet attributes comprise Media Access Control (MAC) addresses.

6. The method according to claim 1, wherein the ports have respective maximum specified ingress and egress bandwidths, and wherein configuring the network element comprises causing the packets to be distributed among the ports such that the packets utilize the ports to their respective maximum ingress and egress bandwidths.

7. The method according to claim 1, wherein the ports have respective maximum specified egress bandwidths, and wherein configuring the network element comprises causing the packets that are forwarded from a given port to be distributed among the other ports responsively to the respective egress bandwidths of the other ports.

8. The method according to claim 1, wherein the ports comprise Ethernet ports.

9. Apparatus for testing a network element that includes multiple ports, the apparatus comprising:
a packet generation/analysis unit, which is coupled to apply a first sequence of packets to an input test port assigned from among the ports, to receive a second sequence of the packets exiting the network element at an output test port assigned from among the ports, and to verify an operation of the network element by evaluating the second sequence, wherein one or more of the ports other than the input and output test ports are terminated with respective loopback connections such that a packet exiting the network element at a given terminated port will re-enter the network element at the given terminated port; and
a processor, which is coupled to configure the network element to forward the packets entering the network element at the input test port, so as to cause the packets to be distributed among the terminated ports and to exit the network element, after re-entering the network element at one or more of the terminated ports, at the output test port.

10. The apparatus according to claim 9, wherein the first sequence comprises multiple sub-sequences of the packets having different, respective packet attributes, and wherein the processor is coupled to cause the network element to forward the sub-sequences over respective, different forwarding paths responsively to the packet attributes.

11. The apparatus according to claim 10, wherein the sub-sequences are associated with different, respective Virtual Local Area Networks (VLANs), and wherein the processor is coupled to define point-to-point VLAN connections between pairs of the ports so as to cause the network element to forward the sub-sequences over the forwarding paths.

12. The apparatus according to claim 11, wherein at least one of the point-to-point VLAN connections comprises a bidirectional VLAN connection, which specifies that the packets that arrive at a first port and are associated with a first VLAN are to be forwarded to a second port and further specifies that the packets that arrive at the second port and are associated with a second VLAN are to be forwarded to the first port, and wherein the processor is coupled to define the bidirectional VLAN connection and to set the second VLAN to a value that is not associated with any of the sub-sequences.

13. The apparatus according to claim 10, wherein the packet attributes comprise Media Access Control (MAC) addresses.

14. The apparatus according to claim 9, wherein the ports have respective maximum specified ingress and egress bandwidths, and wherein the processor is coupled to configure the network element such that the packets utilize the ports to their respective maximum ingress and egress bandwidths.

15. The apparatus according to claim 9, wherein the ports have respective maximum specified egress bandwidths, and wherein the processor is coupled to configure the network element such that the packets that are forwarded from a given port are distributed among the other ports responsively to the respective egress bandwidths of the other ports.

16. The apparatus according to claim 9, wherein the ports comprise Ethernet ports.

17. A computer software product for testing a network element, which includes multiple ports and is connected to a packet generation/analysis unit that applies a first sequence of packets to an input test port assigned from among the ports, receives a second sequence of the packets exiting the network element at an output test port assigned from among the ports, and verifies an operation of the network element by evaluating the second sequence, wherein one or more of the ports other than the input and output test ports are terminated with respective loopback connections such that a packet exiting the network element at a given terminated port will re-enter the network element at the given terminated port, the product comprising a computer-readable medium, in which program instructions are stored, which instructions, when read by a computer, cause the computer to configure the network element to forward the packets entering the network element at the input test port, so as to cause the packets to be distributed among the terminated ports and to exit the network element, after re-entering the network element at one or more of the terminated ports, at the output test port.

18. The product according to claim 17, wherein the first sequence comprises multiple sub-sequences of the packets having different, respective packet attributes, and wherein the instructions cause the computer to cause the network element to forward the sub-sequences over respective, different forwarding paths responsively to the packet attributes.

19. The product according to claim 18, wherein the sub-sequences are associated with different, respective Virtual Local Area Networks (VLANs), and wherein the instructions cause the computer to define point-to-point VLAN connections between pairs of the ports so as to cause the network element to forward the sub-sequences over the forwarding paths.

20. The product according to claim 19, wherein at least one of the point-to-point VLAN connections comprises a bidirectional VLAN connection, which specifies that the packets that arrive at a first port and are associated with a first VLAN are to be forwarded to a second port and further specifies that the packets that arrive at the second port and are associated with a second VLAN are to be forwarded to the first port, and wherein the instructions cause the computer to define the bidirectional VLAN connection and to set the second VLAN to a value that is not associated with any of the sub-sequences.

21. The product according to claim 18, wherein the packet attributes comprise Media Access Control (MAC) addresses.

22. The product according to claim 17, wherein the ports have respective maximum specified ingress and egress bandwidths, and wherein the instructions cause the computer to configure the network element such that the packets utilize the ports to their respective maximum ingress and egress bandwidths.

23. The product according to claim 17, wherein the ports have respective maximum specified egress bandwidths, and wherein the instructions cause the computer to configure the network element such that the packets that are forwarded from a given port are distributed among the other ports responsively to the respective egress bandwidths of the other ports.
